(19) United States
(12) Patent Application Publication
(10) Pub. No.: US 2023/0404117 A1
(43) Pub. Date: Dec. 21, 2023

(54) Popcorn-Based Food Product

(71) Applicant: The Hershey Company, Hershey, PA (US)

(72) Inventors: Supapong Siris, Hummelstown, PA (US); Ryan J. Gorel, Hummelstown, PA (US); Luz Palacios, Austin, TX (US); Mary Ellen Kline, Lancaster, PA (US)

(21) Appl. No.: 18/334,977

(22) Filed: Jun. 14, 2023

Related U.S. Application Data
(60) Provisional application No. 63/366,571, filed on Jun. 17, 2022.

(51) Int. Cl. A23L 7/126; A23L 29/30; A23L 7/165; A23G 1/30

(52) U.S. Cl. CPC A23L 7/126; A23G 1/30; A23L 7/165; A23L 29/30

(57) ABSTRACT

A method of manufacturing a popcorn-based snack product includes mixing a binder syrup; mixing the binder syrup with popcorn to form a dough; forming the dough into a slab; baking the slab; and forming the slab into a plurality of portions. The baking step may be performed before or after the slab is formed into the plurality of portions. The binder syrup includes about 52.0-52.5% by weight tapioca syrup; about 23.5-24.5% by weight tapioca fiber; and about 3.5-5.0% by weight gum Arabic.

### CROSS-REFERENCE TO RELATED APPLICATIONS

This application claims the benefit of priority of U.S. Provisional Patent Application No. 63/366,571, filed Jun. 17, 2022, the disclosure of which is incorporated by reference herein in its entirety.

### FIELD OF THE INVENTION

The invention relates to food products. More specifically, the invention is directed to compositions of popcorn-based food products, and methods for making same.

### SUMMARY

The following presents a simplified summary of the invention in order to provide a basic understanding of some aspects of the invention. The summary is not an extensive overview of the invention. It is not intended to identify the critical elements of the invention or to delineate the scope of the invention. Its sole purpose is to present some concepts of the invention in a simplified form as a prelude to the more detailed description that is presented elsewhere herein.

A popcorn-based snack product includes a binder syrup and popcorn. The binder syrup is about 45-60% by weight tapioca syrup; about 20-30% by weight tapioca fiber; about 1-6% by weight glycerin; about 1-10% by weight sugar; about 1-6% by weight salt; about 1-8% by weight microcrystalline cellulose; about 1-8% by weight gum Arabic; about 1-7% by weight sunflower oil; and about 0-1% by weight soy lecithin.

A method for manufacturing a popcorn-based snack product includes mixing a binder syrup; mixing the binder syrup with popcorn to form a dough; forming the dough into a slab; baking the slab in an oven until the water activity of the slab is less than or equal to about 0.3; and forming the slab into a plurality of portions. The baking step may be performed before or after the slab is formed into a plurality of portions. The binder syrup includes about 52.0-52.5% by weight tapioca syrup; about 23.5-24.5% by weight tapioca fiber; about 3.0-4.0% by weight glycerin; about 4.0-6.0% by weight sugar; about 2.5-4.0% by weight salt; about 3.5-5.0% by weight microcrystalline cellulose; about 3.5-5.0% by weight gum Arabic; about 3.0-4.0% by weight sunflower oil; and about 0-0.4% by weight soy lecithin.

According to another embodiment of the invention, a method of manufacturing a popcorn-based snack product includes mixing a binder syrup; mixing the binder syrup with popcorn to form a dough; forming the dough into a slab; baking the slab; and forming the slab into a plurality of portions. The baking step may be performed before or after the slab is formed into the plurality of portions. The binder syrup includes about 52.0-52.5% by weight tapioca syrup; about 23.5-24.5% by weight tapioca fiber; and about 3.5-5.0% by weight gum Arabic.

### BRIEF DESCRIPTION OF THE DRAWINGS

FIG. 1 is a flow diagram illustrating the method of making a popcorn-based food product according to an embodiment of the invention.

FIG. 2 is a picture of a binder clump coated in popcorn.

FIG. 3A is a picture of a popcorn-based food product formed into bars via a rotary plunger former.

FIG. 3B is another picture of a popcorn-based food product formed into bars via a rotary plunger former.

FIG. 4A is a picture of a popcorn-based food product formed into balls via a rotary plunger former.

FIG. 4B is another picture of a popcorn-based food product formed into balls via a rotary plunger former.

### DETAILED DESCRIPTION

Popcorn-based food products, more precisely popcorn-based snack bars, and their methods of manufacture are known. However, previous popcorn-based snack bars leave much to be desired in taste and texture. A popcorn-based snack product having improved taste, texture, and nutritional value would be beneficial. Embodiments of such a popcorn-based snack product are described herein.

Unless defined otherwise, all technical and scientific terms used herein generally have the same meaning as commonly understood by one of ordinary skill in the art to which this invention belongs. Generally, the nomenclature used herein and the laboratory procedures are those well-known and commonly employed in the art.

As used herein, the articles “a” and “an” refer to one or to more than one (i.e., to at least one) of the grammatical object of the article. By way of example, “an element” means one element or more than one element. Furthermore, use of the term “including” as well as other forms, such as “include”, “includes,” and “included,” is not limiting.

As used herein, the term “about” or “approximately” will be understood by persons of ordinary skill in the art and will vary to some extent on the context in which it is used. As used herein when referring to a measurable value such as an amount, a temporal duration, and the like, the term “about” is meant to encompass variations of ±0-20% from the specified value, as such variations are appropriate to perform the disclosed methods.

The invention is directed to a popcorn-based snack product that has improved taste, texture, and nutritional value. The specific composition of the product may vary slightly between batches because of manufacturing procedures. Nevertheless, the popcorn-based snack product according to the invention is a light, crispy textured snack product that may include chocolate chips. The product may be bottom-enrobed in chocolate or a chocolate compound. Accordingly, the popcorn-based snack product according to embodiments of the invention may generally include a binder syrup, popcorn, chocolate chips, and chocolate or a chocolate compound for enrobing the bottom of the snack product.

The binder syrup may include about 45-60% by weight tapioca syrup, about 20-30% by weight tapioca fiber, about 1-6% by weight glycerin, about 1-10% by weight sugar, about 1-6% by weight salt, about 1-8% by weight microcrystalline cellulose (cellulose gum), about 1-8% by weight gum Arabic, about 1-7% by weight sunflower oil, and about 0-1% by weight soy lecithin.

In an aspect of the invention, the binder syrup may include about 45-55% by weight tapioca syrup, about 20-26% by weight tapioca fiber, about 2-5% by weight glycerin, about 2-7% by weight sugar, about 1-4% by weight salt, about 2-6% by weight cellulose gum, about 2-6% by weight gum Arabic, about 1-5% by weight sunflower oil, and about 0-0.8% by weight soy lecithin.

According to another aspect of the invention, the binder syrup may include about 50-55% by weight tapioca syrup, about 23-25% by weight tapioca fiber, about 4-5% by weight glycerin, about 3-6% by weight sugar, about 2-4% by weight salt, about 3-5% by weight cellulose gum, about 3-5% by weight gum Arabic, about 2-4% by weight sunflower oil, and about 0-0.5% by weight soy lecithin.

In still yet another aspect of the invention, the binder syrup may include about 52.0-52.5% by weight tapioca syrup, about 23.5-24.5% by weight tapioca fiber, about 3.0-4.0% by weight glycerin, about 4.0-6.0% by weight sugar, about 2.5-4.0% by weight salt, about 3.5-5.0% by weight cellulose gum, about 3.5-5.0% by weight gum Arabic, about 3.0-4.0% by weight sunflower oil, and about 0-0.4% by weight soy lecithin.

In a further aspect of the invention, the binder syrup may include about 52.4% by weight tapioca syrup, about 24.0% by weight tapioca fiber, about 3.7% by weight glycerin, about 5.0% by weight sugar, about 3.0% by weight salt, about 4.0% by weight cellulose gum, about 4.0% by weight gum Arabic, about 3.7% by weight sunflower oil, and about 0.2% by weight soy lecithin.

According to embodiments of the invention, the tapioca syrup may have a dextrose equivalent (DE) of between 27 and 95. In an embodiment, the tapioca syrup may have a DE of between 27 and 50. In another embodiment, the tapioca syrup may have a DE of between 27 and 40, or between 27 and 30. In still another embodiment, the tapioca syrup may have a DE of 27, 28, 29, or 30. The gum Arabic may be pre-hydrated.

As is described in greater detail below regarding the method of manufacture of the popcorn-based snack product, the binder syrup is mixed with popcorn. The ratio of binder to popcorn may range from about 1:1 to about 2:1. Preferably, the ratio of binder to popcorn is about 1.25:1 or about 1.20:1. In an embodiment of the invention, the binder syrup accounts for about 52-56% of the binder-popcorn mixture, with popcorn making up the remaining 42-48% of the mixture. Preferably, the binder syrup accounts for about 54% of the mixture, with popcorn making up the remaining about 46% of the mixture.

To aid in coating the popcorn, the viscosity of the binder may be reduced by adding water prior to mixing with popcorn. In embodiments, the binder syrup may include up to about 20% water such that the final ratio of binder syrup to popcorn is about 1.25:1. According to aspects of the invention, the binder syrup may include up to about 9% water such that the final ratio of binder syrup to popcorn is about 1.1:1. In further aspects, the binder syrup may include up to about 7% of water, or about 5% of water, such that the final ratio of binder syrup to popcorn is about 1.25:1. According to still further aspects, the binder syrup may include about 4% of water such that the final ratio of binder to popcorn is about 1.25:1. The water may be baked out of the bar after mixing and before packaging to achieve the desired crunchy texture.

In embodiments, it may be preferable for the binder to be heated before mixing with popcorn. Heating the binder may temporarily reduce the viscosity of the binder to allow for better coating of the popcorn during the popcorn mixing step without requiring water to be added to the binder syrup. Further, heating the binder may aid in dissolving the sugar in the syrup.

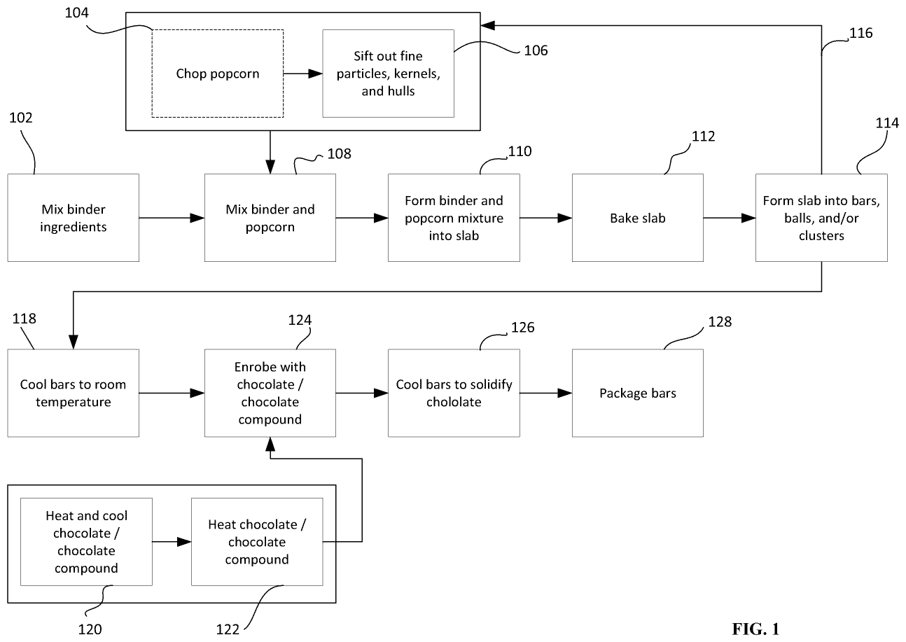

FIG. 1 is a flow diagram illustrating a process 100 for manufacturing a popcorn-based snack product according to an embodiment of the invention, which generally includes mixing the binder, coating popcorn with binder, compressing the coated popcorn to form a slab, forming the slab into individual bars, balls, and/or clusters, and packaging the product for consumer consumption.

The process begins at step 102, wherein the binder ingredients are mixed to form a binder syrup. The binder may be mixed by first adding the wet ingredients (e.g., tapioca syrup, tapioca fiber, glycerin, sunflower oil, and soy lecithin) to a mixer and mixing well to ensure even distribution of ingredients. The dry ingredients (e.g., cellulose gum, gum Arabic, sugar, and salt) may be mixed together and added to the wet ingredients. The binder may be mixed for about 5 minutes to ensure homogenization of the mixture.

As noted above, the binder ingredients may be heated to aid in dissolving the sugar and coating the popcorn. In embodiments where heating is desirable, the binder may be heated to about 100° F.-200° F. It may be preferable for the binder to be heated to about 125° F.-135° F., and more preferably to about 130° F. If water is added to the binder, the heating step may or may not be required.

At step 104, popcorn is chopped into pieces. In some embodiments, the popcorn may be pre-chopped (e.g., may be sourced as a by-product from a popcorn manufacturer), rendering step 104 unnecessary. The popcorn pieces may undergo a separation process at step 106 to remove kernels, pieces of hull and other unwanted material. For example, a fluidized bed filter may be used to separate dense material (e.g., kernels) from light material (e.g., popcorn). Dust collection within the fluidized bed filter may remove the smallest bits of popcorn as well as pieces of hull that have separated from the popcorn. The process then moves to step 108.

At step 108, the popcorn pieces are added to a mixer and the binder syrup is introduced to the popcorn pieces and mixed with the popcorn until the popcorn is fully coated and a dough is formed. In embodiments, popcorn is first added to a mixer, and the binder syrup is added atop the popcorn. The popcorn and the syrup may be mixed for at least about five minutes, or until the popcorn is fully coated.

Flavored chips (e.g., chocolate chips, peanut butter chips, etc.) may be added to the dough at step 108. The chocolate chips may account for about 8-12% by weight of the binder-popcorn-chocolate chip mixture, with the binder accounting for about 47-51% by weight, and the popcorn accounting for about 39-43% by weight of the mixture. Preferably, the chocolate chips account for about 9-11% of the mixture, the binder accounts for about 48-50% by weight of the mixture, and the popcorn accounts for about 40-42% by weight of the mixturee. More preferably, the chocolate chips form about 10% by weight of the mixture, the binder syrup accounts for about 49% by weight of the mixture, and the popcorn accounts for about 41% by weight of the mixture.

It is preferred that the dough is at a temperature of around 95-100° F. at the end of step 108.

Moving on to step 110, once the binder, popcorn, and chocolate chip mixture is able to form a mass, the mass (dough) is prepared for slabbing. The slabbing process may utilize one or more compression rollers, e.g., as part of an extruder, to form the dough into a uniform slab. The gap between the rollers may be between 0.5 and 3 inches, and preferably may be about 0.5-1 inch, more preferably about 0.7 inch. The speed of the belt receiving material from the extruder, and speed of the extruder itself, may be controlled to allow for the proper amount of material to be consistently deposited on the belt to form a continuous slab.

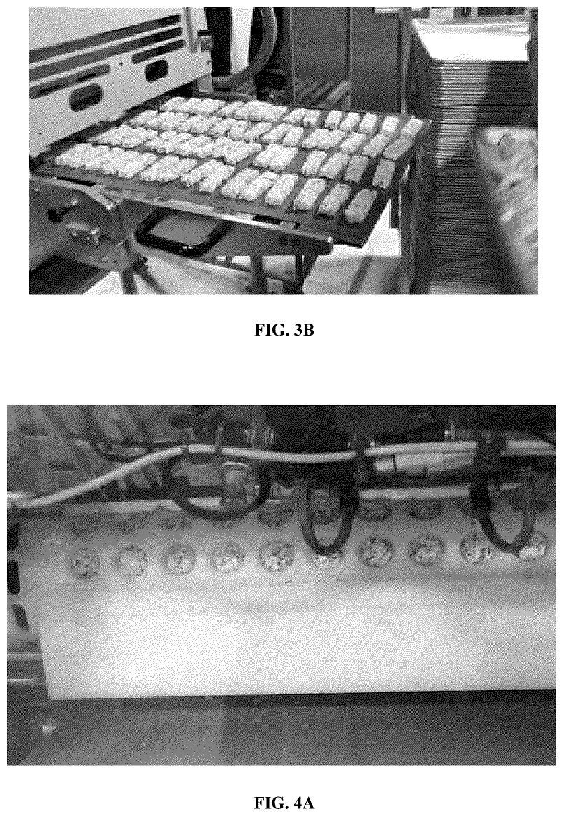

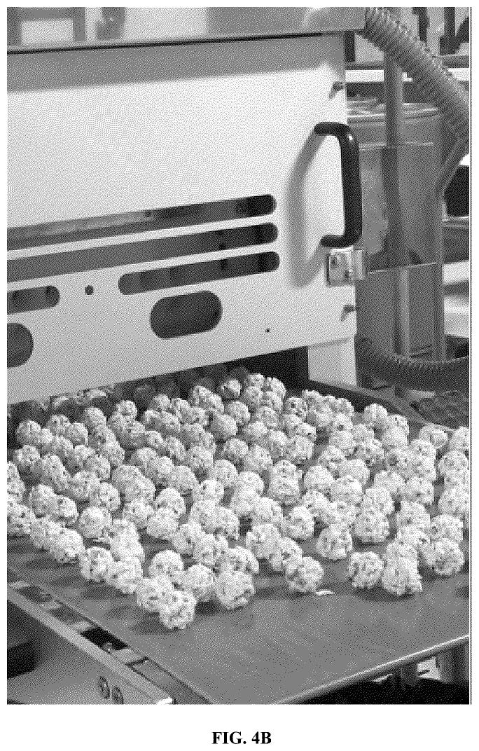

The extruder may be outfitted with a die, allowing individual bars, or in some instances balls or clusters, to be directly output from the extruder. Of course, the die may have any desirable shape for outputting food products, and shall not be limited to bars, balls, or clusters. In a further embodiment, the slab is cut into appropriately sized bars prior to the bars entering the oven. In yet another embodiment, the dough may be passed through a machine such as a rotary plunger former (e.g., Kruger & Salecker Maschinenbau GmbH & Co. KG GFT/GFW Cereal Moulding Machines). The rotary plunger former may output bars (e.g., as shown in FIGS. 3A and 3B) or balls (e.g., as shown in FIGS. 4A and 4B).

In an embodiment, the slab may undergo a pre-compression step. Guardrails may be added to the extruder to assist with guiding the slab onto the belt. Additional post-extrusion compression rollers may be utilized to obtain desirable compression.

In an embodiment, instead of adding the chocolate chips to the dough at step 108, the chocolate chips are added to the dough as the dough passes between compression rollers.

At step 112, the slab exits the extruder and enters the oven for baking to remove excess moisture. The oven temperature may range from about 250° F. to about 400° F., and may depend on the amount of water in the formulation and the thickness of the slab. In an embodiment, the oven may include multiple zones, and the temperature of each of the zones may be independently set. Preferably, the temperature of the zones may independently be between about 300° F. and 400° F. More preferably, the temperature of the zones may independently be between about 340° F. and 350° F., and most preferably about 345° F.

The slab may be baked for about 10-30 minutes. Preferably, the slab is baked for about 15-25 minutes, more preferably from about 17-22 minutes, and most preferably for about 20 minutes. Importantly, the final moisture content of the baked slab after processing should be about 2-3% by weight. The water activity of the bar should be less than or equal to about 0.3.

The slab exits the oven, and the process moves to step 114, where the slab is cut into bars. The slab may be cut into appropriately sized bars with a slitter and/or guillotine according to techniques known to those of skill in the art.

In an embodiment, steps 112 and 114 are switched such that the cutting of the slab (or the forming of bars, balls, and/or clusters) at step 114 takes place prior to the baking step 112. In such embodiments, the temperature may be set to between about 340° F. and 350° F., and the bake time may be reduced to about 2-5 minutes, and may be set to be about 2 minutes, 30 seconds.

In the event that bars, balls, and/or clusters are output from the extruder, or that the slab is cut into bars prior to baking, the baking temperature and/or time may be reduced. According to an aspect of the invention, the baking temperature for bars may be between about 250° F. and 300° F., and the baking temperature for balls and clusters may be between about 275° F. and 325° F. Preferably, the baking temperature for bars is about 275° F. and for balls and clusters is about 300° F. The bake time for bars may be about 18-22 minutes, more preferably about 19-21 minutes, and most preferably about 20 minutes. The bake time for balls and clusters may be about 13-22 minutes, more preferably about 14-21 minutes, and most preferably about 15-20 minutes.

Importantly, regardless of the order of steps 112 and 114, or whether the product is baked as a slab or as bars, balls, and/or clusters, when the product leaves the oven, the product moisture is less than about 4%, and the water activity is less than about 0.3. For ease of preparation, the product may be described as a “bar” but it shall be understood from the foregoing that the product may be a bar as is commonly understood and described herein, or the product may additionally or alternately be formed into balls and/or clusters.

Excess pieces of popcorn from the cutting process may be returned to the process at step 116. Moving on, at step 118, the product is cooled, e.g., in a cooling tunnel, to ambient temperature in preparation for bottom enrobing.

At steps 120 and 122, the chocolate or chocolate compound is prepared. At step 120, the chocolate or chocolate compound is heated and subsequently cooled to allow for crystal formation. At step 122, the chocolate or chocolate compound is reheated, and undesired crystals are removed. The process then moves to step 124.

At step 124, the bottoms of the bars are enrobed in the chocolate or chocolate compound according to techniques known to those of skill in the art. Optionally, the top of the bar may be drizzled with chocolate or chocolate compound. The chocolate or chocolate compound may account for about 30-35% by weight of the overall bar, with binder and popcorn each accounting for about 28-32% by weight of the overall bar, and the chocolate chips accounting for about 4-8% by weight of the overall bar. Preferably, the chocolate or chocolate compound accounts for about 31-34% by weight of the overall weight of the bar, the binder syrup and popcorn each account for about 29-34% by weight of the overall weight of the bar, and the chocolate chips account for about 5-7% by weight of the overall weight of the bar. More preferably, the chocolate or chocolate compound accounts for about 33% by weight of the overall weight of the bar, the binder syrup and popcorn each account for about 30% by weight of the overall weight of the bar, and the chocolate chips account for about 6.7% by weight of the overall weight of the bar. Most preferably, the chocolate or chocolate compound accounts for about 33.3% by weight of the overall weight of the bar, the binder syrup and popcorn each account for about 30.02% by weight of the overall weight of the bar, and the chocolate chips account for about 6.67% by weight of the overall weight of the bar. It shall be understood that the bar may be enrobed and and/or drizzled with any coating agent, such as a peanut butter compound.

The process then moves to step 126, where the bars are cooled (e.g., in a cooling tunnel) to solidify the chocolate or chocolate compound. At step 128, the bars are packaged and sealed for delivery to consumers.

### Experimentation

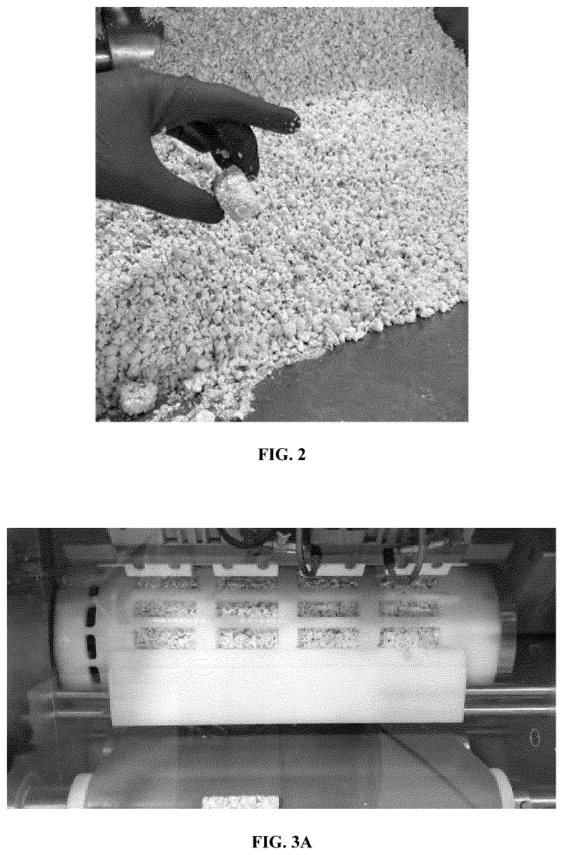

Experimentation resulted in a determination that the lowest binder-to-popcorn ratio that allows for complete coating of the popcorn is 1.25:1 if water is not added to the binder syrup before mixing with popcorn. At a 1:1 binder-to-popcorn ratio, it was found that clumps of binder coated in popcorn formed, with some popcorn remaining uncoated. FIG. 2 illustrates a binder clump coated in popcorn. At a binder-to-popcorn ratio of 2:1, the popcorn was fully coated and able to form a mass. In further experiments, the binder-to-popcorn ratio was reduced to get as close to a 1:1 ratio as possible while achieving full coating of the popcorn and ability of the popcorn to form a mass for further processing. The binder-to-popcorn ratio impacts the final brix and water activity (aw) of the finished bar. Table 1, below, shows the brix and water activity of the finished bar at various binder-to-popcorn ratios. For the trials in Table 1, water was not added to the binder syrup.

TABLE 1

| | Binder to | Final | Binder | Oven |
|---|---|---|---|---|
| | Popcorn ratio | Brix | aw | Temp |
| BATCH 1 | 1:1 | 85 | 0.1712 | — |
| BATCH 2 | 2:1 | 82.9 | 0.163 | 400 |
| BATCH 3 | 1.5:1 | 81.9 | 0.1623 | 400 |
| BATCH 4 | 1.1:1 | 80.3 | 0.1647 | — |

At a binder-to-popcorn ratio of 1.25:1, the resulting bar had a chewier texture, which led to experimenting with adding water to the binder syrup prior to mixing with the popcorn.

Table 2 illustrates the effect of adding water on the brix and water activity of the finished bar.

TABLE 2

| | % | Initial | Final | Binder | Mass | Oven |
|---|---|---|---|---|---|---|
| | Water | Brix | Brix | aw | aw | Temp |
| BATCH 1 | 0% | 81.6 | 82.9 | 0.6952 | — | — |
| BATCH 2 | 20% | 59.8 | 61.7 | 0.8591 | 0.8349 | 375 |
| BATCH 3 | 9.1% | 71.1 | 72.8 | 0.823 | 0.6893 | 350 |
| BATCH 4 | 4.7% | 75.3 | 76.5 | 0.7892 | 0.5933 | 335 |
| BATCH 5 | 7.0% | 74.4 | 75.1 | 0.8134 | 0.6117 | 315 |
| BATCH 6 | 9.1% | 74.7 | No heat | 0.8327 | 0.6915 | 365 |
| BATCH 7 | 9.1% | 75 | No heat | 0.8318 | 0.7183 | 345 |

At 20% water (equal to 1.25:1 binder-to-popcorn ratio), the binder was able to fully coat the popcorn. However, the popcorn was soggy. The amount of water was decreased to 4%, and was added to the mixer with the remaining binder ingredients. The binder was heated, and mixed with popcorn. At 4% of the formulation, and having been heated, the binder fully coated the popcorn. It was also possible to bake out the excess moisture in an oven to achieve a final moisture content of around 2-3% w/w. However, heating the binder resulted in the chocolate chips melting when added to the binder and popcorn mixture.

In binder formulations that included water, it was observed that heating the binder only resulted in a small increase in degrees brix (i.e., less than about 1 degree versus 5-7 degrees when mixing the binder without water). This demonstrates that heating the binder mixture does not dissolve a significant amount of additional sugar.

Without heating, the binder formulation with 4% water was unable fully coat the popcorn, and binder clumps were observed. Moreover, when the mass was fed through the extruder, it was observed that the chocolate chips had fallen to the bottom of the bar, and ultimately fell out of the mass and remained on the belt.

To reduce the viscosity of the binder without requiring heating prior to coating the popcorn, the percentage of water was increased to 9% (equal to 1.1:1 binder-to-popcorn ratio). This binder formula was able to evenly coat the popcorn. Moreover, the binder also coated the chocolate chips, allowing the chocolate chips to adhere to the popcorn mass and not fall to the bottom of the bar during downstream processing.

Various extruder settings were tested to determine the ideal settings. In an embodiment, the gap between the rollers in the extruder was set to 2 inches, and a die with a 1-inch gap was situated at the outlet of the roll extruder. The mass was unable to be extruded through the die. With the die removed, the mass was able to exit the extruder in compressed masses. A pre-compression step was added prior to the extruder. The gap between the rollers in the extruder was set to 0.5 inch, and the material was pressed into a slab. At a 0.5-inch gap, it was determined that the slab was too thin, and gaps were observed. The gap was increased to 0.7 inch, and it was possible to extrude a slab without gaps. The height of the resulting slab varied slightly, with heights ranging from about 0.67 to about 0.74″, measured across the band. Notably, reducing the binder-to-popcorn ratio did not have a noticeable effect on how easily the slab was formed.

Oven temperatures ranging from about 250° F. to about 400° F. were tried in various combinations, and were generally based on the amount of water in the binder formulation and the thickness of the slab. The initial trials are summarized in Table 3, below.

TABLE 3

| Batch | | | | | |
|---|---|---|---|---|---|
| 2 | 3 | 4 | 5 | 6 | 7 |

Zone 1

| | | | | | | |
|---|---|---|---|---|---|---|
| TOP | 375 | 350 | 335 | 315 | 365 | 345 |
| BOTTOM | 375 | 350 | 335 | 300 | 355 | 330 |

Zone 2

| | | | | | | |
|---|---|---|---|---|---|---|
| TOP | 375 | 350 | 335 | 315 | 365 | 345 |
| BOTTOM | 375 | 350 | 335 | 315 | 365 | 345 |

Zone 3

| | | | | | | |
|---|---|---|---|---|---|---|
| TOP | 375 | 350 | 335 | 315 | 365 | 345 |
| BOTTOM | 375 | 350 | 335 | 315 | 365 | 345 |

According to the initial trails, it was determined that the optimal oven conditions were a bake time of about 20 minutes at a temperature of 345° F. in all zones.

Further baking trials were completed for situations in which bars and balls were extruded through a die. Tables 4 and 5 illustrate the results of the trials, which confirm that as the baking time increases, the moisture and water activity in the product decreases.

TABLE 4
Bars

| Temperature | 275 F. | 275 F. | 275 F. | 275 F. | 275 F. |
|---|---|---|---|---|---|
| Time | 10 min | 15 min | 17 min | 20 min | 25 min |
| Moisture | 6.229 | 4.835 | 4.256 | 3.198 | 3.343 |
| Water Activity | 0.391 | 0.2956 | 0.2479 | 0.2594 | 0.1984 |

TABLE 5
Balls

| Temperature | 300 F. | 300 F. |
|---|---|---|
| Time | 10 min | 15 min |
| Moisture | 4.605 | 2.901 |
| Water Activity | 0.3484 | 0.2313 |

Many different arrangements of the described invention are possible without departing from the spirit and scope of the invention. Embodiments of the invention are described herein with the intent to be illustrative rather than restrictive. Alternative embodiments will become apparent to those skilled in the art that do not depart from its scope. A skilled artisan may develop alternative means of implementing the disclosed improvements without depart from the scope of the invention.

Further, it will be understood that certain features and subcombinations are of utility and may be employed without reference to other features and subcombinations and are contemplated within the scope of the claims. Not all steps listed in the various figures and description need to be carried out in the specific order described. The description should not be restricted to the specific described embodiments.

1. A popcorn-based snack product, comprising:
a binder syrup, comprising:
about 45-60% by weight tapioca syrup;
about 20-30% by weight tapioca fiber;
about 1-6% by weight glycerin;
about 1-10% by weight sugar;
about 1-6% by weight salt;
about 1-8% by weight microcrystalline cellulose;
about 1-8% by weight gum Arabic;
about 1-7% by weight sunflower oil; and
about 0-1% by weight soy lecithin; and
popcorn.

2. The popcorn-based snack product of claim 1, wherein a final water activity of the snack product is less than or equal to about 0.3.

3. The popcorn-based snack product of claim 1, wherein a ratio of the binder syrup to the popcorn is about 1.25:1.

4. The popcorn-based snack product of claim 1, wherein the binder syrup accounts for approximately 54% by weight of the total weight of the snack product.

5. The popcorn-based snack product of claim 1, further comprising chocolate chips.

6. The popcorn-based snack product of claim 5, wherein the chocolate chips account for approximately 10% of the total weight of the snack product, and the binder syrup accounts for approximately 49% of the total weight of the snack product.

7. The popcorn-based snack product of claim 1, wherein the binder syrup comprises:
about 52.0-52.5% by weight tapioca syrup;
about 23.5-24.5% by weight tapioca fiber;
about 3.0-4.0% by weight glycerin;
about 4.0-6.0% by weight sugar;
about 2.5-4.0% by weight salt;
about 3.5-5.0% by weight microcrystalline cellulose;
about 3.5-5.0% by weight gum Arabic;
about 3.0-4.0% by weight sunflower oil; and
about 0-0.4% by weight soy lecithin.

8. The popcorn-based snack product of claim 3, wherein the binder syrup comprises:
about 52.4% by weight tapioca syrup;
about 24.0% by weight tapioca fiber;
about 3.7% by weight glycerin;
about 5.0% by weight sugar;
about 3.0% by weight salt;
about 4.0% by weight microcrystalline cellulose;
about 4.0% by weight gum Arabic;
about 3.7% by weight sunflower oil; and
about 0.2% by weight soy lecithin.

9. A method of manufacturing a popcorn-based snack product, comprising:
mixing a binder syrup, comprising:
about 52.0-52.5% by weight tapioca syrup;
about 23.5-24.5% by weight tapioca fiber;
about 3.0-4.0% by weight glycerin;
about 4.0-6.0% by weight sugar;
about 2.5-4.0% by weight salt;
about 3.5-5.0% by weight microcrystalline cellulose;
about 3.5-5.0% by weight gum Arabic;
about 3.0-4.0% by weight sunflower oil; and
about 0-0.4% by weight soy lecithin;
mixing the binder syrup with popcorn to form a dough;
forming the dough into a slab;
baking the slab in an oven until the water activity of the slab is less than or equal to about 0.3; and
forming the slab into a plurality of portions;
wherein the baking step may be performed before or after the slab is formed into the plurality of portions; and
wherein a ratio of the binder syrup to the popcorn is about 1.25:1.

10. The method of claim 9, wherein the binder syrup is mixed with the popcorn such that the binder syrup accounts for about 54% by weight of the dough.

11. The method of claim 10, further comprising mixing chocolate chips into the dough to form a chocolate chip containing dough, wherein the chocolate chips account for about 10% by weight of the chocolate chip containing dough and the binder syrup accounts for about 49% by weight of the chocolate chip containing dough.

12. The method of claim 11, wherein the chocolate chips are mixed into the dough prior to forming the dough into the slab.

13. The method of claim 12, further comprising heating the binder to a temperature of about 100-200° F., wherein a temperature of the dough after mixing in the chocolate chips is about 95-100° F.

14. The method of claim 9, further comprising bottom enrobing each of the plurality of portions with a chocolate compound.

15. The method of claim 9, wherein the popcorn is chopped and sifted prior to mixing with the binder.

16. The method of claim 9, wherein the plurality of portions comprises bars, balls, and/or clusters.

17. The method of claim 9, wherein the baking occurs at a temperature of between about 300 and 400° F.

18. A method of manufacturing a popcorn-based snack product, comprising:
mixing a binder syrup, comprising:
about 52.0-52.5% by weight tapioca syrup;
about 23.5-24.5% by weight tapioca fiber; and
about 3.5-5.0% by weight gum Arabic;
mixing the binder syrup with popcorn to form a dough;
forming the dough into a slab;
baking the slab; and
forming the slab into a plurality of portions;
wherein the baking step may be performed before or after the slab is formed into the plurality of portions.

19. The method of claim 18, wherein the baking occurs at a temperature of between about 300 and 400° F.

20. The method of claim 19, wherein a final water activity of the snack product after the baking step is less than or equal to about 0.3.
